(19) United States
(12) Patent Application Publication
(10) Pub. No.: US 2012/0037834 A1
(43) Pub. Date: Feb. 16, 2012

(54) Method and apparatus for venting gas from liquid-conveying conduit

(75) Inventors: Rudolph J. Lang, III, St. Charles, IL (US); Anthony John Witheridge, Batavia, IL (US)

(73) Assignee: International Valve Manufacturing, L.L.C., St. Charles, IL (US)

(21) Appl. No.: 12/806,414

(22) Filed: Aug. 12, 2010

(51) Int. Cl. F16K 24/04; F16K 27/00

(52) U.S. Cl. 251/368; 137/202

(57) ABSTRACT

A valve-venting method increases the durability of flow restrictors within gas venting valves used on large diameter water and sewer pipelines such that transient high pressure conditions that can cause rapid adiabatic heating of the discharging gases are prevented from causing flow erosion and debris wear induced by the high velocities and thermal softening of the valve components. The method utilizes wear resistant orifice inserts that are more conductive than the valve component to better distribute the heat, and dynamic surge control geometry to slow the heat flow and provide progressive water-hammering control during high pressure events.

### BACKGROUND OF THE INVENTION

1. Field of the Invention

The present invention generally relates to valves and valve methodology. More particularly, the present invention relates to a valve-based apparatus and method for use with large diameter water and sewerage pipelines to provide controlled means for allowing gases to be released when the pipeline is pressurized or filled, and to allow air to enter into the pipeline when the internal pressure of the pipeline drops below atmospheric pressure.

2. Brief Description of the Prior Art

Large pipelines that supply water or transport sewerage often transverse undulating terrain. This is one reason why the proper operation of these pipelines requires the removal of air pockets that may form during operation or during the filling process. Similarly, pipelines occasionally experience negative pressures that may be due to emptying, pumping disruptions, and maintenance or failure conditions. Regardless of the reason, large diameter pipelines are prone to damage under negative pressure conditions and venting valves that allow the ingress of air can be a necessary design requirement.

The prior art shows and describes several types of pipeline venting valves, some of which have been successfully marketed. Certain of the prior art valves utilize small floats that operate the valve closure using mechanical advantage offered by sets of hinges and levers as exemplified by U.S. Pat. Nos. 4,114,641; 4,635,672; 5,090,439; 5,386,844; 5,988,201; 7,617,838; and 4,209,032. Certain other of the prior art valves avoid the maintenance problems associated with levers by using larger direct acting floats as exemplified by U.S. Pat. Nos. 5,511,577; 2,853,092; 4,579,140; 4,586,528; 4,696,321; 4,742,843; and 5,769,429. Still certain other of the prior art valves do not allow the ingress of large volumes of air into the pipeline under negative pressure conditions while other valves vent only small amounts of air that accumulate under normal pipeline operations, and other valves have multiple venting modes that allow large flow rates of air into and out of the pipeline as exemplified by U.S. Pat. Nos. 5,511,577 and 6,513,541.

During the pipeline filling process, however, these high-flow valves also need to transition progressively between high air flow discharge and small trickle flow to minimize damage caused by momentary pressure spikes from water-hammering effects, which are induced when a large mass of fast flowing water comes to a rapid stop or with sizable and abrupt changes in velocity. One example of such an attempt is described in U.S. Pat. No. 5,511,577, in which a stack of cylindrical valve members, each with an increasingly sized passageway, is sequentially sealed against the valve's outlet (i.e. if high air flow indicates water hammering potential, then the sequential activation of each valve member will progressively slow the discharge rate). However, in practice, it has been found that the implementation of multiple, sequentially activated valve members to control water hammering is both difficult and generally impractical, hence just one anti-hammering valve member is used to provide the restriction needed when shifting between high and low air flow discharge.

The use of large, high-capacity pumps connected to these pipelines in conjunction with vertical terrain changes can result in the rapid compression of large gas pockets. This condition is especially prevalent when long sections of a pipeline are being filled during commissioning or after maintenance operations. Given the common pressure ratings for these valves are high (10, 16 and 25 bar), those large pumps can induce rapid adiabatic compression, which can result in short discharge periods of high temperature gas.

With regard to valves that use a float component with a restrictive hole to minimize water-hammer such as described in U.S. Pat. Nos. 5,511,577 and 6,513,541, one problem encountered in the field is that the anti-water-hammer orifice in the buoyant plastic float will soften due to the elevated gas temperatures and be more easily abraded by high velocity rust and grit particles entrained in the gas by the unusually high velocities. In some cases the gas temperature exceeds the melting point of the float material causing the control orifice to greatly enlarge and require valve inspection and float replacement.

The larger the pipeline the larger the valves, some of which can weigh over a hundred kilograms, and given the considerable length of the pipelines, the large number of valves used and the frequent man-hole access difficulties, the cost of maintenance is high. Consequently, the value to the end user of highly dependable, low maintenance venting valves is significant.

### SUMMARY OF THE INVENTION

The prior art thus perceives a need for certain means to allow gases in large diameter water and sewerage pipelines to be released when the pipeline is pressurized or filled, and to allow air to enter into the pipeline when the internal pressure of the pipeline drops below atmospheric pressure. Further, the prior art perceives a need for a venting valve that can withstand a wider range of adverse operating conditions without incurring additional maintenance that has proved necessary in the past.

To meet these and other readily apparent objectives, the venting valves according to the present invention bleed off small amounts of air and other gases that may form or accumulate during the normal operations of a pipeline. In all these conditions, the release of gases from the pipeline is controlled by use of internal floats that activate various closure mechanisms. Under certain circumstances the release of gas from the pipeline can be highly energetic with pressures in the 10 to 100 bar range, the gas exit velocities and temperatures can be high and enough to cause damage to the polymers normally utilized in the valve. The energetic conditions can generate liquid aerosols containing fine particles and also dislodge fine debris including rust particles from the surface of the pipeline and eject them at high velocity through the discharge orifices of the valve causing erosion. This invention describes design improvements that specifically address both these problems.

The present invention further pertains to a method of increasing the durability of the anti-water-hammering (or anti-surge) components used in venting valves, which service pipelines with diameters 4 inches or greater. This is achieved by the use of annulus shaped inserts placed onto or into a valve member (or anti-surge) float to protect the discharge passageway/s by reducing the wear rate during high pressure gas discharge. The shape of the insert is not limited to that of an annulus and can include designs utilizing a wide array of internal hole shapes and external shape configurations that achieve the same objective.

The anti-surge valve components are typically composed of High Density Polyethylene (HDPE) or other light-weight materials that are soft and/or have low melting points. An unexpected benefit from using anti-wear inserts is that they provide a mechanism for distributing the heat load over a larger volume of the float (or valve member), which assists in managing the adverse impact of transient high temperature effects on the valve member cause by rapid adiabatic compression of the venting gas. The choice of material used to make the inserts can be either conducting or an insulation material like a ceramic; both have benefits in preventing the float material from melting under transient conditions.

Using components that better manage that brief period of elevated temperature is one way to increase the durability of the valve, however, slowing the flow of air through the valve when exceptionally high surge pressures are encountered is also useful, because it both decreases the heat load entering the valve and permits the hot gasses to shed the heat to the surrounding pipeline and liquid contents. Subsequently, a method to induce dynamic restriction of the gas flow is claimed, wherein the occurrence of exceptional high pressures will further limit the gas flow through the orifices of the anti-hammer valve member.

### BRIEF DESCRIPTION OF THE DRAWINGS

FIG. 1 is a top perspective view of the vent valve apparatus according to the present invention showing the centerline (i-i) used to project the sectional views used to detail the present invention.

FIG. 2 is a longitudinal sectional view of a vent valve apparatus as sectioned from FIG. 1 depicting the structural configuration of internal components for venting gas when the vent valve apparatus is venting gas under relatively low pressure.

FIG. 3 is a longitudinal sectional view of a vent valve apparatus as sectioned from FIG. 1 depicting the structural configuration of internal components for venting gas when the vent valve apparatus is venting gas under relatively high pressure.

FIG. 4 is a fragmentary enlarged view as sectioned from FIG. 3 detailing the pathway of gases when the valve is venting gas under relatively low pressure and specifically showing the close proximity of flange termini to the outlets of the gas passageways, which termini offer little restriction to flow because a significant gap is provided by an uncompressed O-ring.

FIG. 5 is a fragmentary enlarged view as sectioned from FIG. 3 detailing the pathway of gases when the valve is venting gas under relatively high pressure and specifically showing the close proximity of flange termini to the outlets of the gas passageways, which termini offer substantial restriction to flow because little or no gap is provided by the compressed O-ring.

FIG. 6 is a sectional view of an anti-water-hammer valve member fitted with tapered anti-wear inserts.

FIG. 7 is an enlarged longitudinal cross-sectional view of a first cylindrical anti-wear insert used to structurally protect the inlets of passageways formed in the float member according to the present invention.

FIG. 8 is an enlarged longitudinal cross-sectional view of a tapered anti-wear insert used to structurally protect the inlets of passageways formed in the float member according to the present invention.

FIG. 9 is an enlarged longitudinal cross-sectional view of a second cylindrical anti-wear insert according to the present invention formed from two materials, namely, a first radially inner material and a second radially outer material.

FIG. 10 is an enlarged longitudinal cross-sectional view of a third cylindrical anti-wear insert according to the present invention formed from two materials, namely, a first axially upper material and a second axially lower material.

FIG. 11 is a generic, diagrammatic depiction of a circular inner transverse cross-section of an anti-wear insert according to the present invention.

FIG. 12 is a generic, diagrammatic depiction of an elliptical inner transverse cross-section of an anti-wear insert according to the present invention.

FIG. 13 is a generic, diagrammatic depiction of a series of exemplary polygonal inner transverse cross-sections of anti-wear insert(s) according to the present invention, including from left to right a triangular inner transverse cross-section, a rectangular inner transverse cross-section, and a hexagonal inner transverse cross-section.

### DETAILED DESCRIPTION OF THE PREFERRED EMBODIMENT

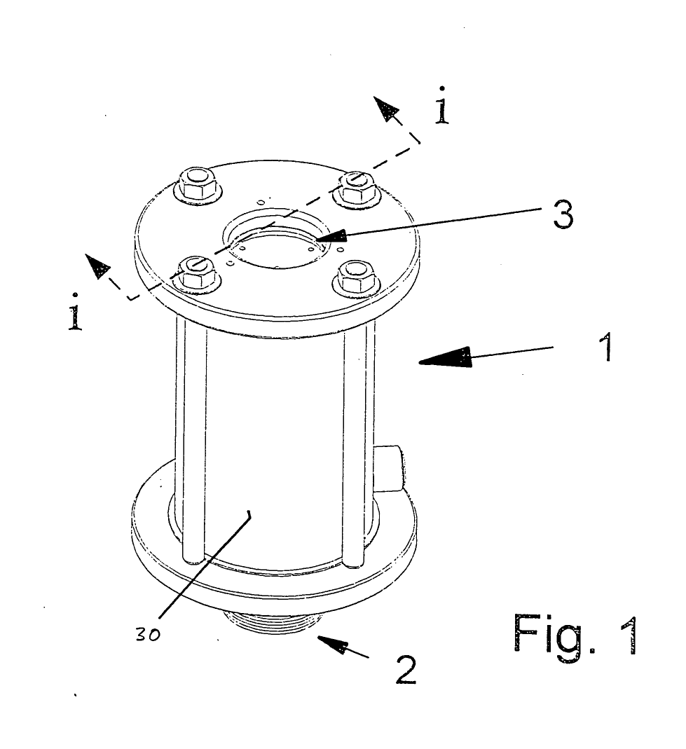

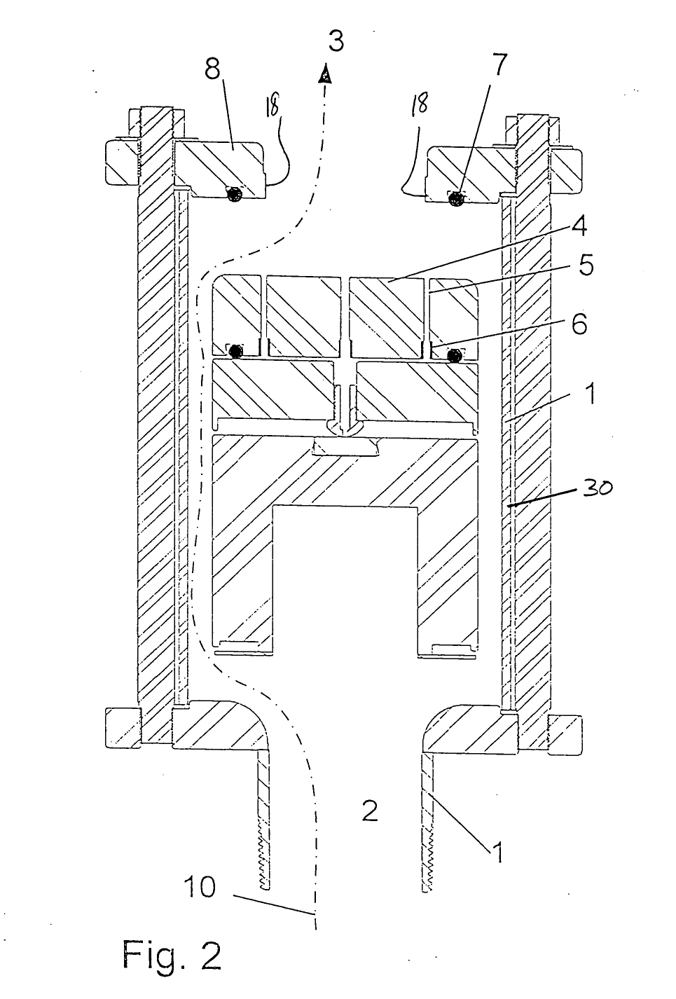

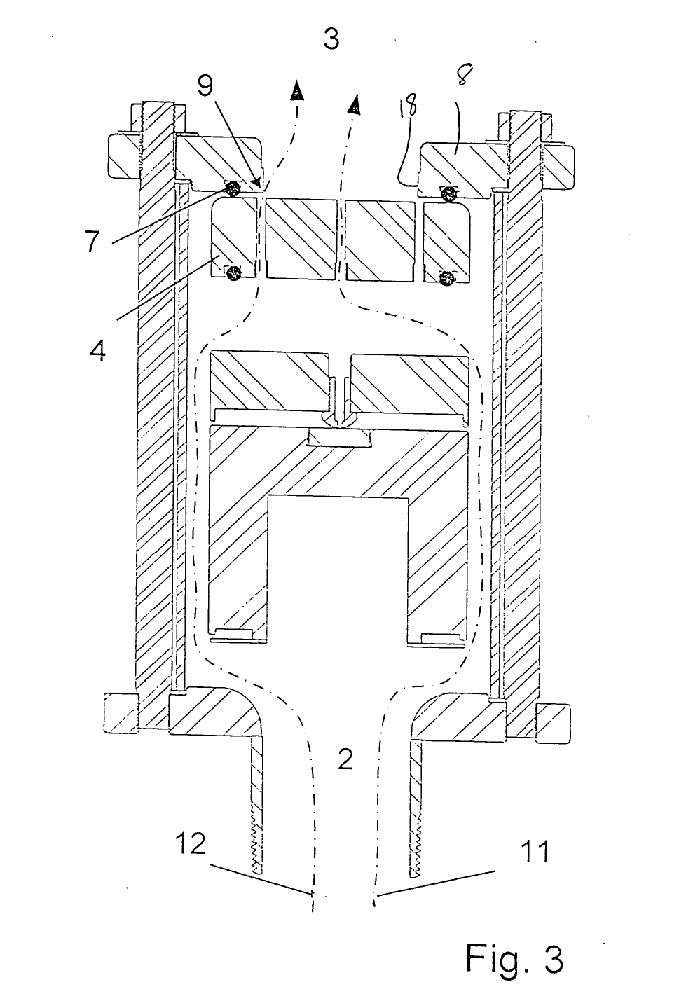

Referring now to the drawings with more specificity, the preferred embodiment of the present invention concerns a vent valve apparatus 1 as generally depicted in FIGS. 1-3, in which FIGS. 2 and 3 are longitudinal sectional views of the apparatus 1 otherwise perspectively depicted in FIG. 1. In this last regard, FIG. 2 is a longitudinal sectional view of the vent valve apparatus 1 according to the present invention depicting the structural configuration of internal components for venting gas when the vent valve apparatus is venting gas under low pressure and at flow rates typically less than 30 meters per second (via pathway 10) inletting at the apparatus inlet as referenced at 2, and exhausting to the apparatus outlet (as referenced at 3) via the outlet flange 8.

FIG. 3 is a longitudinal sectional view of the vent valve apparatus 1 according to the present invention depicting the structural configuration of internal components for venting gas when the vent valve apparatus 1 is venting gas under moderate or relatively increased pressure and at flows typically greater than 30 meters per second (via pathways 11 and 12), showing that under these conditions, the higher air velocity has lifted the anti-water-hammer valve or float member 4 so as to seat it against the top or upper o-ring 7 and forcing the gas through restrictive passageway(s) 5 formed in the float or valve member 4, which passageway(s) 5 are protected by the anti-wear insert(s) 6.

Central to the practice of the present invention certain is a valve design incorporating the use of one or more anti-water-hammer valve members or floats as generally referenced at 4 and as depicted in FIGS. 2-5, and 7. In other words, the apparatus 1 according to the present invention comprises one or more anti-water-hammer float or valve members 4 that have flow-limiting orifice/s or passageways as at 5 extending intermediate a first or outlet surface 20 and a second or inlet surface 21 of the float member 4, which orifices or passageways 5 are used to inhibit water-hammering or to otherwise moderate similar effects.

In this last regard, it is contemplated that the invention can also be applied to a variety of pressure relief valve constructions that suffer from similar wear and/or high temperature effects. The invention further preferably incorporates the use of an insert as depicted and referenced at 6 and/or 14 placed into or onto or around the flow-limiting orifice/s 5 at the inlet surface 11 of the float or valve member(s) 4, which inserts 6 or 14 are sufficiently durable so as to resist mechanical erosion, corrosion, and unlikely to melt under transient pipeline conditions.

In conjunction to using an insert as exemplified by insert 6 or insert 14, the invention preferably uses an array of small passageways 5 widely spaced throughout the float member 4 (or valve member) which passageways 5 offer additional assistance in distributing the heat throughout the float member 4 (or valve member as the case may be). It is contemplated that the inserts 6 may be preferably constructed from a robust yet thermally conductive material such as 316 Stainless Steel or alternatively from a less thermally conductive material such as glass, high-alumina or zirconia ceramic. The material used in the construction of the inserts 6 or 14 should inhibit the passageway(s) 5 from collapsing and/or becoming obstructed so as to prevent passage of gases therethrough as, for example, by way of melting of the material surrounding the passageway(s) under the absorption of thermal energy.

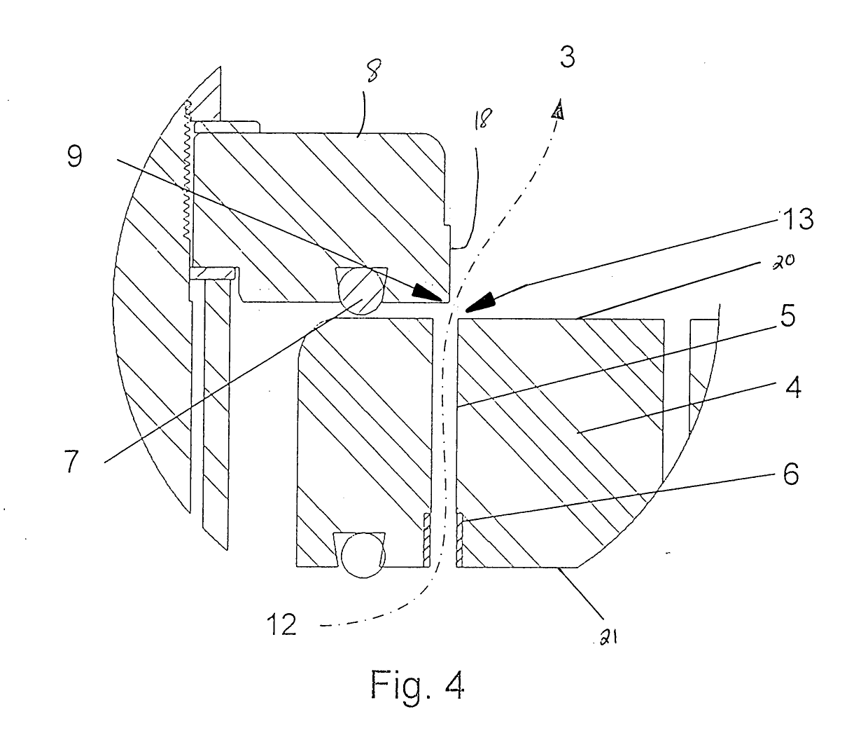

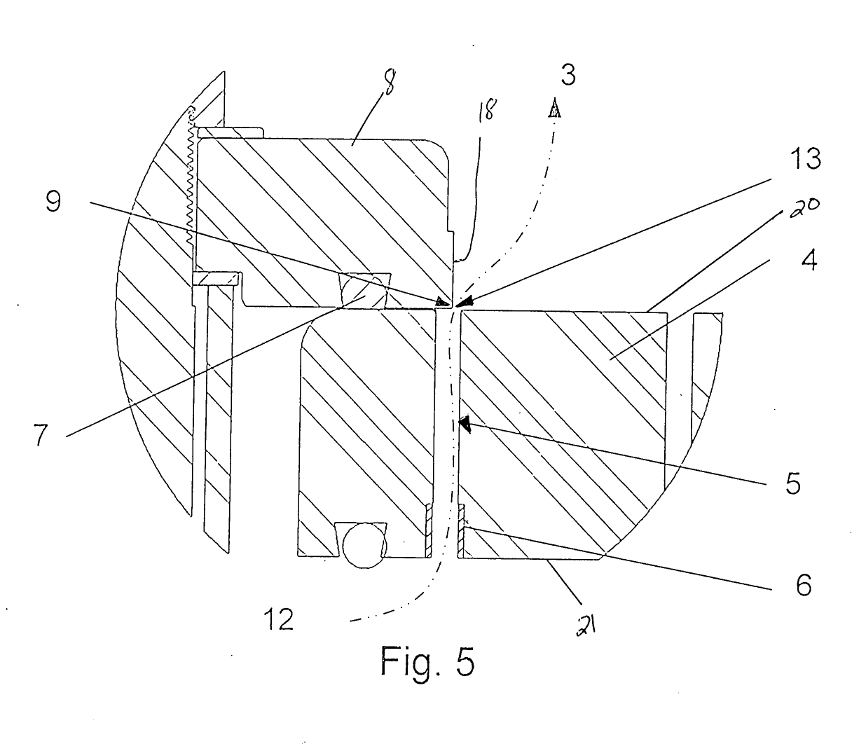

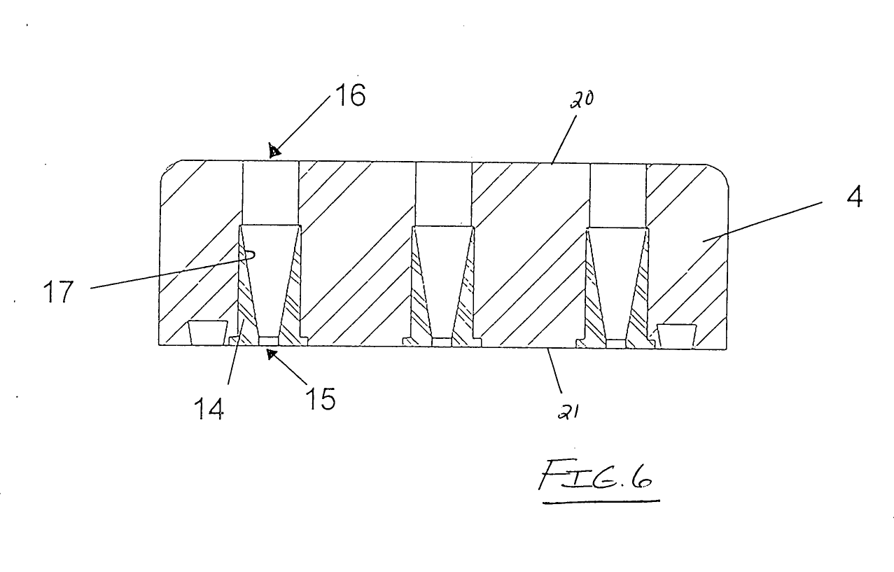

The invention further encompasses the use of dynamic changes in mechanical clearance induced by exceptional high pipe pressures. In this example, several of the smaller passageways 5 in the float member 4 or valve member that vent the air are located so that their outlet's cross-section as at 13 is partially obscured as at 9 by the inner portion(s) or termini 18 of an outlet flange 8 to which the float member 4 seats directly or indirectly as generally and comparatively depicted in FIGS. 4 and 5. In other words, the inner termini 18 of the outlet flange 8 terminate such that the outlets 13 of the passageways 5 (at the outlet surface 20) are partially obscured by the inner termini 18 when the float or valve member 4 becomes forced thereagainst by relatively increased pressure within the pipeline.

When such a design utilizes an o-ring 7 or other compressible sealing component between the float member 4 and the flange 8, then under mild pressure (e.g. 1 bar), gas will discharge from the passageways 5 with only a little restriction as generally depicted in FIG. 4. As the pressure increases, however, the o-ring 7 (or similar other sealing means) may compress and thus progressively decrease the gas flow rates by progressively obstructing the size of the passageway's outlet 13 with maximum obstruction being established at less than 16 bar.

To suitably balance the effects, the combined discharge area of all the passageways 5 needs to be increased more than that when using unobstructed passageways. The net effect is to induce dynamic flow control under high pressure conditions. The effect can be adjusted using multiple o-rings or changing the hardness, diameter or otherwise affecting the compression characteristics of the sealing component. Slowing the gas discharge under exceptionally high pipe pressure conditions lowers the immediate heat stress on the float member 4 and also provides more time for the gases to transfer their heat to the surrounding pipeline and liquid contents and thereby cool.

A simple implementation of the invention would be to attach an anti-wear annulus insert 6 and/or 14 into the entrance or inlet of the passageway(s) 5. The insert(s) 6 and/or 14 could conceivably and preferably be made from a metal washer or a cylindrical metal section, which may or may not traverse the entire length of the respective passageway and in some cases, may protrude. An inlet aperture or hole 15 in the insert 6 or 14 allows the passage of gas and the diameter of the inlet hole or aperture 15 would provide the primary restriction required to throttle the gas flows.

The preferred metallic construction of the insert(s) 6 and/or 14 is contemplated to both resist wear and help distribute heat to a greater volume of the float component 4. More complex implementations may include inner and/or outer ceramic layers to impart both improved wear resistance but also to better manage the heat transfer within the insert 6 and/or 14 and into the body of the float member 4. Other materials can be use for similar effect. A further rendition of this invention is to utilize expanding passageways 17 as in insert 14 to induce gas cooling, which in combination with a heat conducting insert 14 allows for the dissipation of the higher temperatures seen at the passageway's entrance as shown in FIG. 6.

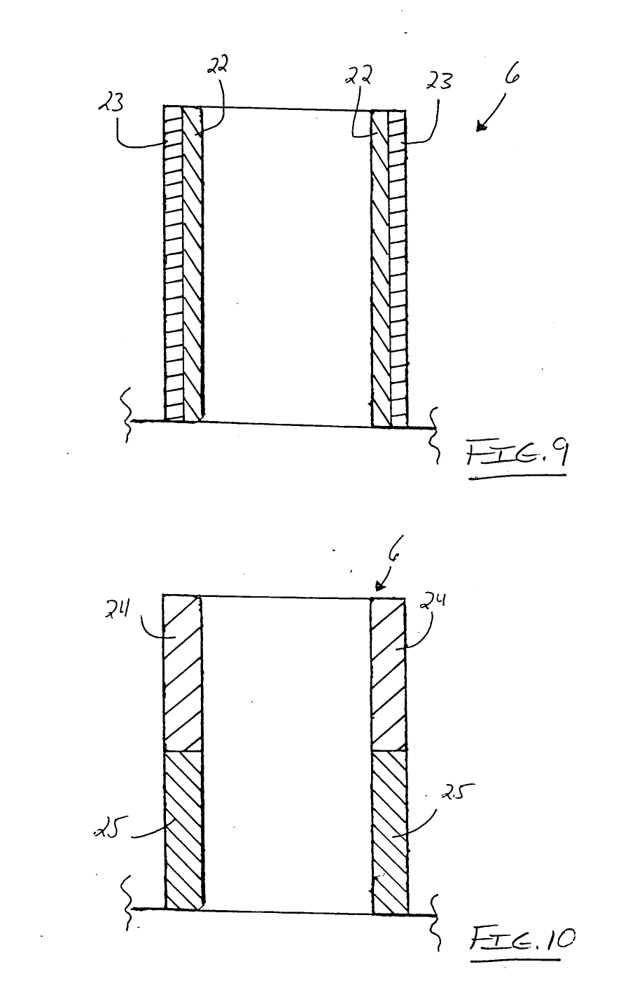

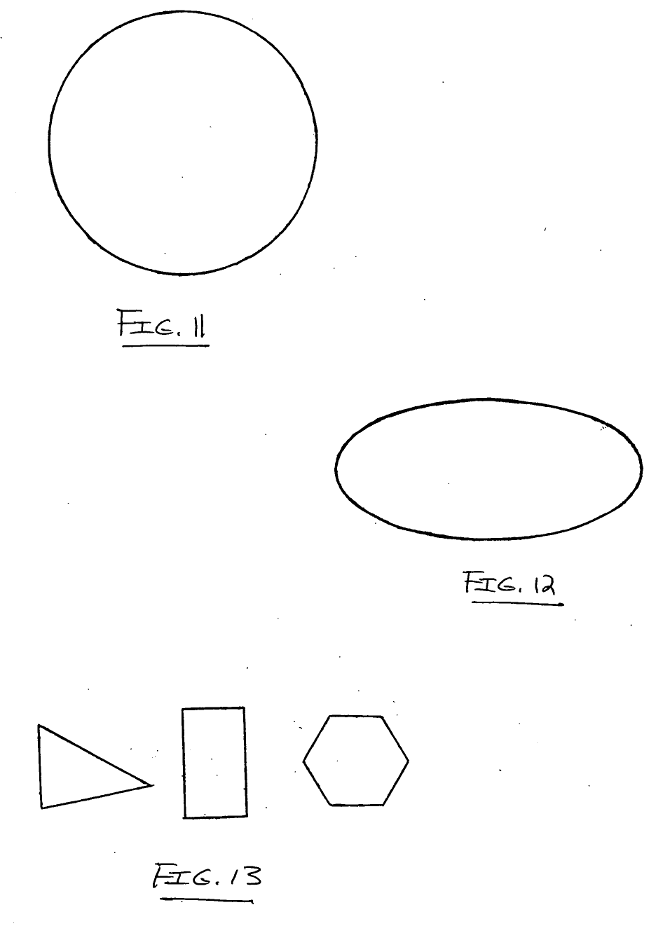

In this last regard, it will be noted that insert 6 differs from insert 14 insofar as insert 6 comprises a substantially uniform inner transverse cross-section or inner diameter as at 100 while the inner transverse cross-section or inner diameter of insert 14 differs along the axial length of insert 14. In other words, the passageway 17 of each insert 14 expands from the inlet aperture 15 to the outlet aperture 16 to achieve the function(s) earlier stated. Other shapes of the transverse inner cross-sections of the of the inserts 6 and/or 14 are contemplated, including a circular or round inner cross-section as generically depicted in FIG. 11; an elliptical inner cross-section as generically depicted in FIG. 12; and various polygonal shapes, several generic shapes of which are depicted in FIG. 13, including from left to right a triangular inner cross-section, a rectangular inner cross-section and a hexagonal inner cross-section.

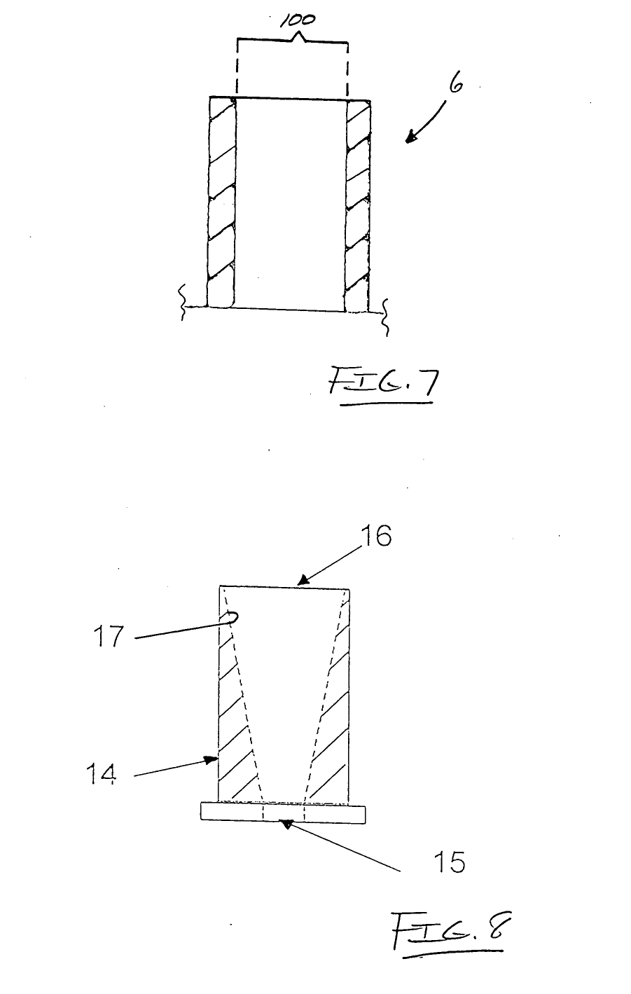

In keeping with the notion of providing differing structures for inducing dynamic thermodynamic activity at the anti-wear insert site(s), the reader is further directed to FIGS. 9 and 10. From a consideration of the noted figures, it will be understood that the anti-wear inserts according to the present invention may be constructed from differing materials so as to influence differing heat transfer rates. FIG. 9, for example, depicts a cylindrical anti-wear insert 6 formed from two materials axially aligned and radially bound, namely, a first radially inner material as at 22 and a second radially outer material as at 23.

By way of contrast, FIG. 10 depicts a cylindrical anti-wear insert 6 formed from two materials axially aligned and transversely bound, namely, a first axially upper material 24 and a second axially lower material 25. It is contemplated that the user may control heat transfer rates through the inserts by specifying the types of multiple materials used in the construction of the inserts. Preferably, the anti-wear inserts are composed of a substance having heat-conductivity at least 75% greater than the main material construction of the anti-surge or float member 4 through which the venting gases pass.

The present invention may thus be said to support certain methodology for increasing the durability of flow restricting orifices or passageways formed in float members within anti-surge components of venting-valves used for venting gases out of water and sewer pipelines typically over 100 mm in diameter. In this regard, the method may be said to comprise a series of steps including placing one or more anti-wear inserts into or around the flow restricting orifices, which inserts are preferably constructed from or comprise one or more materials having greater hardness than the main body of the float member or component so as to increase the wear resistance of the orifice to particulate or debris that can be entrained in the venting gases being ejected though said orifice.

The invention may also be said to support a method for increasing the durability of flow restricting orifices within anti-surge components of venting—valves used for venting gases out of water and sewer pipelines over 100 mm in diameter, wherein one or more inserts are placed into or around the flow restricting orifices, and such inserts are composed of a substance with a heat-conductivity more than 75% greater than the main body of the anti-surge or float member or component through which the flow limiting orifices are formed.

The method for increasing the durability of flow restricting orifices within anti-surge components of venting—devices used for venting gases out of water and sewer pipelines (generally over 100 mm in diameter) may be said to further be defined by locating the outlets of some or all of the flow restricting orifices in proximity to one or more components (such as outlet flange 8) of the valve body, which components are fixed relative to the axially displacable or movable anti-surge component or float member 4. At pressures between 1 bar and 16 bar, the flow from those orifices is preferably restricted by more than 30% due to complete or partial mechanical obstruction caused by the progressive compression of an o-ring (as at 7) or similar other equivalent elastic or spring like member used to separate the said fixed component and the anti-surge component; wherein pressure surges induce an increasing restriction to the flow though those orifices.

The anti-wear energy-conductive inserts (as exemplified by inserts 6 and/or 14) integrated into the float member 4 thus provide a double function, namely, as anti-wear inserts for increasing the durability of flow restricting orifices or passageways formed in the float members and as heat-conductive inserts for enabling the installer to control heat flow at the insert site. In this last regard, it is contemplated that the inserts may comprise circular or round inner transverse cross-sections, elliptical inner transverse cross-sections, or generic polygonal inner transverse cross-sections according to the installation specifications and/or application in which the venting valve apparatus 1 is integrated.

Further, the inner transverse cross-section(s) of the inserts may remain substantially constant (e.g. insert 6) or expand long the axis of flow (e.g. insert 14). In the latter case, it is contemplated that the induced gas expansion enabled by the expanding cross-section facilitates cooling of the insert (e.g. 14). Still further, the inserts may be constructed from one or more materials, each of which may be selected based on differing thermal conductivity characteristics so as to enable the user to more particularly control heat transfer within the apparatus 1.

While the foregoing sets forth much specificity, this specificity should not be construed as limitations on the scope of the invention, but rather as an exemplification of the invention. For example, as is described hereinabove, it is contemplated that while the present invention essentially discloses a valve apparatus for venting gas from liquid-conveying conduit (such as a water or sewer pipeline generally over 100 mm in diameter), which valve apparatus essentially comprises an apparatus inlet as at 2, an apparatus outlet as at 3, an outer valve body as at 30, and a float member as at 4.

The float member according to the present invention comprises an inlet surface as at 21, an outlet surface as at 20, and at least one, but preferably a series of gas-venting pathways 5 extending intermediate the inlet and outlet surfaces 21 and 20. The pathways or orifices 5 are preferably outfitted with anti-wear inserts (as at 6 or 14) at the inlet surface 21 for enhancing wear resistance of the pathways 5 at the inlet surface 21. Notably, the float member 4 is axially displaceable intermediate the valve body 30 under varied gas flow rates within the valve body 30 as comparatively depicted in FIG. 2 versus FIG. 3 and FIG. 4 versus FIG. 5.

The valve apparatus may further comprise certain obstruction means at the apparatus outlet 3 for obstructing or restricting the egress of gas flow from the pathways 5 at the outlet surface 20 during relatively high gas flow rates. The obstruction means may be preferably defined by various fixed structure of which outlet flange 8 is an exemplary structure. The outlet flange 8 extends radially inwardly and comprises flange termini 18, which termini 18 obstruct the pathways 15 at the outlet surface 20 of the float member 4 during relatively high gas flow rates. The obstruction means preferably restrict gas flow rates more than 30% during relatively high gas flow rates.

During relatively high gas flow rates, certain (elastic) sealing means intermediate said obstruction means and said float member 4 may well function to enhance control of gas flow rates through the valve apparatus 1 It is contemplated that the sealing means may be preferably defined by an O-ring as at 7 or similar other elastic structure. Via the elastic properties of the sealing means, the apparatus 1 may well effect dynamic adjustments to gas flow rates under varying pressures via compression and relaxation of the sealing means under varied pressure(s).

The inserts integrated into the float member may each have a select inner transverse cross-section, which select inner transverse cross-section may be selected from the group consisting of a round, elliptical or polygon cross-section. Further, the cross-sections of the pathways may well comprise a select flow-defining cross-section for defining gas flow therethrough, which select flow-defining cross-section may be selected from the group consisting of (1) a substantially uniform cross-section (as exemplified by insert 6) for maintaining uniform gas flow rates and (2) an expanding cross-section (as at 17) for enabling gas flow to expand along the axis of flow, wherein the induced gas expansion facilitates cooling of the insert (e.g. insert 14).

In addition to the anti-wear characteristics of the inserts, it is contemplated that the valve apparatus 1 may further incorporate thermally conductive inserts for enabling controlled heat transfer at the insert sites. In this regard, it is contemplated that the inserts may comprise at least one or two thermally conductive material(s) for enabling heat transfer from the gas flow to the float member via the inserts. Should the inserts comprise at least two thermally conductive materials, it is contemplated that the two thermally conductive materials would preferably comprise differing thermal conductivity characteristics and be structurally arranged for enhancing the user's ability to control heat transfer from the gas flow to the float member. Notably, while the inserts are preferably constructed from a first thermally conductive material, the float member is preferably constructed from a second thermally conductive material, wherein the first thermally conductive material has at least 75% greater thermal conductivity relative to the second thermally conductive material.

Accordingly, although the invention has been described by reference to certain preferred embodiment(s) and certain methodology, it is not intended that the novel arrangement and methods be limited thereby, but that modifications thereof are intended to be included as falling within the broad scope and spirit of the foregoing disclosures and the appended drawings.

We claim:

1. A method for increasing the durability of flow restricting orifices within anti-surge components of venting—valves used for venting gases out of pipelines, the method comprising the step of placing one or more inserts into or around flow restricting orifices formed in a float member of a valve apparatus, the inserts comprising a material with greater hardness than the float member so as to increase the wear resistance of the orifice to particulate or debris that can be entrained in the venting gases being ejected though said orifice.

2. The method of claim 1 wherein each insert has a round, elliptical or polygon inner transverse cross-section.

3. The method of claim 1 wherein the cross-section of each respective orifice (1) is substantially uniform or (2) expands along the axis of flow, wherein induced gas expansion in cross-section (2) facilitates cooling of each respective insert.

4. The method of claim 1 wherein each insert comprises one or more materials, each material having a different thermal conductivity characteristic.

5. A method for increasing the durability of flow restricting orifices within anti-surge components of venting—valves used for venting gases out of pipelines, the method comprising the step of placing one or more inserts into or around flow restricting orifices of a float member, said inserts being constructed from a substance having a heat-conductivity characteristic at least 75% greater than the material construction of the float member.

6. The method of claim 5 wherein each insert has a round, elliptical or polygon inner transverse cross-section.

7. The method of claim 5 wherein the cross-section of each respective orifice (1) is substantially uniform or (2) expands along the axis of flow, wherein induced gas expansion in cross-section (2) facilitates cooling of each respective insert.

8. The method of claim 5 wherein each insert comprises one or more materials, each material having a different thermal conductivity characteristic.

9. A method for increasing the durability of flow restricting orifices within anti-surge components of venting devices used for venting pipeline gases, the method comprising the steps of locating the outlet(s) of some or all of the flow-restricting orifices of a movable anti-surge component in proximity to one or more components of a valve apparatus, said components being fixed relative to the movable anti-surge component such that at pressures between 1 bar and 16 bar, flows from said orifices are restricted by more than 30% due to complete or partial mechanical obstruction caused by the progressive compression of elastic sealing means located intermediate said fixed component and said anti-surge component; wherein pressure surges induce an increasing restriction to the flows though said orifices.

10. A valve apparatus for venting gas from liquid-conveying conduit, the valve apparatus comprising:
an apparatus inlet, an apparatus outlet, an outer valve body, and a float member, the float member being axially displaceable intermediate the valve body under varied gas flow rates within the valve body, the float member comprising an inlet surface, an outlet surface and a series of gas venting pathways extending intermediate the inlet and outlet surfaces, the pathways being outfitted with anti-wear inserts adjacent the inlet surface for enhancing wear resistance of the pathways at the inlet surface.

11. The valve apparatus of claim 10 wherein the apparatus outlet comprises obstruction means for obstructing egress of gas flow from the pathways at the outlet surface during relatively high gas flow rates.

12. The valve apparatus of claim 11 wherein the obstruction means are defined by an outlet flange, the outlet flange extending radially inwardly and comprising flange termini, the flange termini obstructing the pathways at the outlet surface of the float member during relatively high gas flow rates.

13. The valve apparatus of claim 11 comprising sealing means intermediate said obstruction means and said float member for enhancing control of gas flow rates through said valve apparatus.

14. The valve apparatus of claim 12 wherein said obstruction means operates to restrict gas flow rates more than 30% during relatively high gas flow rates.

15. The valve apparatus of claim 13 wherein said sealing means are elastic and thereby effect dynamic adjustments to gas flow rates under varying pressures.

16. The valve apparatus of claim 10 wherein the inserts each have a select inner transverse cross-section, the select inner transverse cross-section being selected from the group consisting of a round, elliptical or polygon cross-section.

17. The valve apparatus of claim 10 wherein the cross-sections of the pathways comprise a select flow-defining cross-section for defining gas flow therethrough, the select flow-defining cross-section being selected from the group consisting of (1) a substantially uniform cross-section for maintaining substantially uniform gas flow rates and (2) an expanding cross-section for enabling gas flow to expand along the axis of flow, wherein the induced gas expansion facilitates cooling of the insert.

18. The valve apparatus of claim 10 wherein the inserts comprise at least one thermally conductive material for enabling heat transfer from the gas flow to the float member.

19. The valve apparatus of claim 18 wherein the inserts comprise at least two thermally conductive materials, the two thermally conductive materials having differing thermal conductivity for enhancing the user's ability to control heat transfer from the gas flow to the float member.

20. The valve apparatus of claim 10 wherein the inserts are constructed from a first thermally conductive material and the float member is constructed from a second thermally conductive material, the first thermally conductive material having 75% greater thermal conductivity relative to the second thermally conductive material.
